(19) United States
(12) Patent Application Publication
(10) Pub. No.: US 2026/0163148 A1
(43) Pub. Date: Jun. 11, 2026

(54) Body-in-White with a Drive Battery

(71) Applicant: Mercedes-Benz Group AG, Stuttgart (DE)

(72) Inventors: Juergen REINHARDT, Plochingen (DE); Jan ZICKWERT, Eppstein (DE); Hubert KAZMAIER, Wannweil (DE); Thomas NEFF, Leinfelden-Echterdingen (DE); Jochen BISINGER, Esslingen (DE); Jan RATH, Boeblingen (DE); Jan HELBER, Balingen (DE)

(21) Appl. No.: 18/708,386

(22) PCT Filed: Oct. 25, 2022
(86) PCT No.: PCT/EP2022/079786

§ 371 Date: May 8, 2024

(30) Foreign Application Priority Data
Nov. 9, 2021 (DE) 10 2021 005 515.2

(51) Int. Cl. H01M 50/242; B60K 1/04; B62D 21/07; H01M 50/249; H01M 50/258

(52) U.S. Cl. CPC H01M 50/242; B60K 1/04; B62D 21/07; H01M 50/249; H01M 50/258; B60K 2001/0438

(57) ABSTRACT

A body-in-white of a passenger car includes a frame structure which is peripherally closed and delimits a receiving space for a drive battery. The frame structure is formed by first cross members which are spaced apart from one another in a longitudinal direction and by first side members which are spaced apart from one another in a transverse direction. Second side members adjoin the frame structure in the longitudinal direction. Third side members and second cross members are disposed in the receiving space. The third side members connect the first cross members to one another and the second cross members connect the first side members to one another. The second side members adjoining the frame structure, as viewed in the longitudinal direction, each have, in a connection region to a respective first cross member, at least a partial overlap with the corresponding third side member disposed within the receiving space.

### BACKGROUND AND SUMMARY OF THE INVENTION

The invention relates to a body-in-white of a passenger car.

Document DE 10 2019 006 812A1 , in this field describes a motor vehicle body-in-white with a peripherally closed frame structure which is formed by cross members of the motor vehicle body-in-white spaced apart from one another in the longitudinal direction of the vehicle and by side members of the motor vehicle body-in-white spaced apart from one another in the transverse direction of the vehicle and which delimits a receiving space for receiving an electrical energy storage unit. In the front end of the motor vehicle, there are provided side members of a main side member plane, to the front end region of which a bending cross member of a bumper device is attached and which are connected at least indirectly to the frame structure at their other end region. In the event of a frontal impact of the motor vehicle, the crash forces are introduced into the frame structure via the side members. In order to be able to guarantee the protection of the energy storage unit, the frame structure must therefore be suitably solid so that it does not deform to a critical extent.

The object of the invention is therefore to create a body-in-white of the type mentioned here, in which a lower weight can be realized compared to the known body-in-white while maintaining good protection of the energy storage unit.

In a passenger car with a drive battery, also known as a traction battery, high-voltage storage battery or cycle battery, a plurality of side members and a plurality of cross members are arranged in a receiving space for battery modules of the drive battery. The receiving space and thus the drive battery modules arranged therein are preferably sealed off from the outside by a battery cover. The drive battery is used to supply electrical power to at least one electric prime mover for driving the vehicle.

The body-in-white comprises cross members that are spaced apart in the longitudinal direction of the vehicle and side members that are spaced apart in the transverse direction of the vehicle, which form a peripherally closed frame structure that defines a receiving space for accommodating the drive battery, which has a number of battery modules. The body-in-white also has side members that adjoin the frame structure in the longitudinal direction of the vehicle and extend into the front end and/or into the rear end of the vehicle.

According to the invention, a plurality of side members and a plurality of cross members are arranged in the receiving space for the battery modules, wherein these side members connect the cross members of the body-in-white and these cross members connect the side members of the body-in-white to one another. Furthermore, it is provided that the side members—viewed in the longitudinal direction of the vehicle (x-direction)—which are connected to the frame structure each have, in their connection region to the respective cross members, at least a partial overlap with the corresponding cross member arranged within the receiving space in such a way that, in the event of a collision-induced application of force to at least one of the side members, a load path (L1, L2) free of offset in the transverse direction of the motor vehicle is formed between the side member and the side member arranged directly behind it in the receiving space.

The body-in-white is also referred to as the body. The side members and/or cross members in the receiving space for the battery modules are in particular each made of metal, in particular as profiles. The side members and cross members are used in particular to create a ladder frame structure in the receiving space for the battery modules, which is also connected in particular to the side members of the body-in-white.

For safety reasons, for example to prevent spontaneous combustion, the drive battery must not be subjected to intrusion in standard crash load cases, such as in a side impact test with a pole. In the prior art, this is achieved by further reinforcements in the body-in-white, which, however, increase the weight of the battery electric vehicle, which means that range potentials cannot be fully utilized. This is avoided by the solution according to the invention.

The range of electric vehicles is fundamentally determined by efficiency and therefore by consumption in kWh/100 km and also by the usable installed battery capacity. Particularly with relatively large and heavy vehicles, such as SUVs, the aim is therefore to maximize the installed battery capacity in the vehicle.

The solution according to the invention optimizes the usable battery installation space in the passenger car so that a long electric range is possible while complying with safety requirements.

In order to avoid a heavy, rigid battery housing and additional reinforcements to ensure crash performance in the body-in-white of the passenger car around the drive battery, the battery, or more precisely the structure according to the invention formed of side members and cross members in the receiving space for the battery modules, contributes to the rigidity and strength of the body-in-white. The side members and cross members are integrated into the drive battery or at least into its receiving space. In the event of a front or rear collision or a side collision, they guide the load path optimally or at least optimally through the drive battery, which means that any forces that occur cannot act on the battery. Advantageously, the solution described achieves load paths that are kink-free or at least as kink-free as possible. The solution according to the invention enables an optimized flow of force along the side members and cross members in accordance with the load path curves given or adjusted by their arrangement relative to one another, which loads at least the side members in the receiving space at least predominantly, preferably completely, in tension or compression along their longitudinal axis.

The solution according to the invention also makes it possible, for example, to integrate sensors for measuring mechanical stresses, such as strain gauges, and/or temperature sensors and/or gas sensors, in particular for detecting gases escaping from the individual cells of the drive battery, into the side members and/or cross members in the receiving space. This enables so-called health-monitoring, i.e., in particular condition monitoring, of the drive battery. In one possible embodiment, it is therefore envisaged that one or more sensors for measuring mechanical stresses, for example strain gauges, and/or one or more temperature sensors and/or one or more gas sensors are each integrated in at least one of the side members or several or all of the side members and/or in at least one of the cross members or several or all of the cross members in the receiving space for the battery modules.

Alternatively or additionally, the solution according to the invention enables, for example, the integration of a cooling function, in particular in the battery cover, which is arranged in particular underneath the drive battery. For this purpose, the battery cover is advantageously designed as a sandwich construction. In one possible embodiment, it is therefore envisaged that the cooling function is integrated into the battery cover, which is advantageously of sandwich construction.

In the following, advantageous exemplary embodiments of the invention are explained in more detail with reference to the drawings.

### BRIEF DESCRIPTION OF THE DRAWINGS

FIG. 1 shows a perspective view of a detail of a first exemplary embodiment of a passenger car with a drive battery; and

FIG. 2 shows a schematic plan view of the body-in-white of a further exemplary embodiment of a passenger car with a drive battery.

### DETAILED DESCRIPTION OF THE DRAWINGS

Corresponding parts are provided with the same reference signs in all figures.

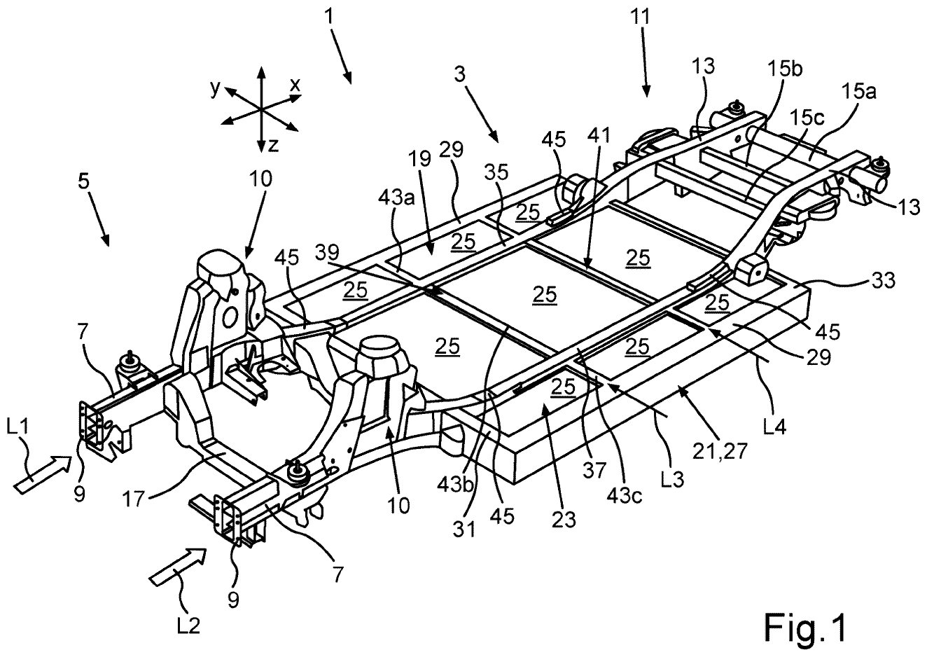

FIG. 1 shows a perspective view of a detail of a first exemplary embodiment of a passenger car 1 according to the invention. A part of a body-in-white 3 of the passenger car 1, also known as the supporting structure or body, can be seen. Two side members 7 of a main side member plane are arranged in a front end structure 5 of the passenger car 1, spaced apart from each other in the transverse direction of the vehicle, and a bending cross member of a bumper device, not shown here, is attached to the free ends of these side members—in the completed state of the passenger car 1. For this purpose, attachment points 9 with flanges are provided at the ends of the side members 7 in the exemplary embodiment shown. The bumper bending cross member is either attached directly to the side members 7 or indirectly to energy absorption elements, also known as crash boxes, arranged between the side members 7 and the bending cross member. Damper leg brackets 10 are attached to the side members 7. Alternatively, these can also be formed in one piece with the side members 7, especially if these are formed as a cast component.

The passenger car 1 also comprises a rear end structure 11, comprising side members 13 and cross members 15a to 15c connecting them to one another. A similar cross member 17 connects the side members 7 arranged in the front end region of the vehicle.

A drive battery 19 integrated into the body is located in the central region of the body, which is arranged between the front end structure 5 and the rear end structure 11 in the region of a passenger cell provided in the completed state of the passenger car 1. In the context of the present invention, a “drive battery” is understood to mean an electrical energy storage unit in which electrical energy or electrical current can be stored. The energy storage unit is a traction storage unit, i.e., it is used to supply electrical energy to at least one electric motor for driving the passenger car 1. In order to drive the passenger car 1 electrically by means of the electric machine, the electric machine is operated in motor mode and thus as an electric motor.

Various challenges arise when integrating such a drive battery 19 into the vehicle 1. For example, the aim is to achieve the greatest possible installed battery capacity and an optimum ratio between the protection of individual cells of the drive battery 19 and a supporting structure of the drive battery 19. Furthermore, there should be as few duplicate structures as possible in the body-in-white of the passenger car 1 and in a battery housing 21 of the drive battery 19, if such a housing is present. In addition, the aim is to achieve lightweight construction throughout the passenger car 1, a cooling-optimized arrangement of the electrics and electronics, and functional integration of the drive battery 19 in the body-in-white.

The solution described below meets these challenges. According to the invention, it is provided that a receiving space 23 for battery modules 25 of the drive battery 19 has a frame structure 27 which is peripherally closed and comprises outer side members 29 which are arranged at a distance from one another in the transverse direction of the motor vehicle (y-direction in the motor vehicle coordinate system) and which are connected to one another via a front cross member 31 and a rear cross member 33—as viewed in the longitudinal direction of the motor vehicle (x-direction in the motor vehicle coordinate system). The outer side members 29 not only delimit the receiving space 23 towards the outside, but also simultaneously form side sills known in car body construction or in each case a part of such a side sill, which forms the side sill with at least one further car body part, for example a side wall of the car body, or a further side sill part. The respective side sill and the side sill part/element can be designed as an extruded profile part or as a sheet-metal shell profile part. The outer side members 29 are then adjoined by a known side wall structure of the passenger car.

Further side members 35 and 37 are provided within the frame structure 27 described above; in the exemplary embodiment according to FIG. 1, precisely two side members, which are arranged at a distance from the outer side members 29 and also at a distance from one another. These side members 35, 37 are connected at the ends to the front and rear cross members 31, 33 of the frame structure 27, i.e., are attached thereto. Furthermore, several cross members 39, 41 are arranged within the receiving space 23, in the exemplary embodiment according to FIG. 1 exactly two cross members, which, like the side members 35, 37, are in particular each made of metal. Each of the cross members 39, 41 arranged in the longitudinal direction of the vehicle at a distance from one another and in each case also at a distance from the respective neighboring cross member 31, 33 of the frame structure 27 is composed of three partial elements in this exemplary embodiment, wherein a first cross-member part element 43a connects the outer side member 29 and the neighboring side member 35, a second cross-member part element 43b connects the two inner side members 35 and 37 arranged within the receiving space 23, and a third cross-member part element 43c connects the inner side member 37 and the other outer side member 29. The cross-member part elements 43a to 43c each connect to the side regions of the respective side members. This creates continuous connections between the outer side members 29 in the transverse direction of the motor vehicle, via which load paths L3 and L4 are formed from one side of the motor vehicle to the other in the event of a side collision. In an alternative exemplary embodiment, the cross members 39, 41 or only one of these cross members can be continuous, i.e., connected at least indirectly to the outer side members 29 at the ends. In this case, the respective inner side member 35, 37 is designed in a correspondingly multi-part manner, wherein the corresponding side-member part elements also connect to the cross members on the inside in this case.

It should be noted that at least one battery module 25 is accommodated between the side members 29, 35, 37, 29 and the cross members 31, 33, 39, 41, in each case in rectangular spaces formed here within the receiving space 23. The fact that the battery modules 25 are arranged between the side members and cross members means that they are not subjected to mechanical loads in the event of a crash, i.e., if forces are introduced into the body-in-white in the event of a collision between the passenger car and an obstacle. The load paths within the receiving space 23 therefore run between the individual battery modules 25 and not through them.

It can also be seen in FIG. 1 that the individual battery modules 25 have different external dimensions and that the free spaces provided to accommodate them between the side member and cross member structures of the receiving space 23 are correspondingly large, i.e., of different sizes in this case. Preferably, the battery modules 25 and their receiving spaces are matched to each other in such a way that the power capacity of the drive battery 19 is as large as possible. For this purpose, it is preferable that the battery modules 25 fill the respective free space of the grid structure formed by the longitudinal and cross members 29, 35, 37, 29 and 31, 39, 41, 33 as completely or almost completely as possible.

The receiving space 23 is closed at the top, i.e., on its side facing a passenger compartment, by means of a cover element or a flat main floor element (not shown), preferably sealed. Towards the bottom, i.e., in the direction of a carriageway, at least one cover element is also provided to seal the receiving space 23 and/or an impact protection element to protect the battery when it touches down on the ground. In order to be able to ensure accessibility to the storage compartment 23 in the completed state of the passenger car 1, for example for maintenance or replacement of individual battery modules 25, at least one of the cover elements is preferably detachably, in particular non-destructively detachably, attached to the body-in-white 3, for example screwed on. Maintenance openings provided in the cover elements are also conceivable.

As is readily apparent from FIG. 1, the side members 7 arranged in the front end structure 5 and the side members 13 arranged in the rear end structure 11—viewed in the longitudinal direction of the vehicle (x-direction)—each have a certain overlap with the side member 35 or 37 arranged within the receiving space 21 in their connection region to the respective cross member 31 or 33 of the frame structure 27. This quasi-aligned or partially aligned arrangement of the respective side member 7 with the side member 36 or 37 arranged behind it and the side member 13 connected behind it in the longitudinal direction of the vehicle, at least in their mutual connection regions and adjacent connection regions, results in a ladder frame structure, so to speak, as is otherwise only seen in the case of lorries. In the event of a frontal collision or an impact on the rear end structure, this design of the body-in-white 3 according to the invention therefore enables continuous, optimum force guidance through the receiving space 23 past the battery modules 25. In other words, the battery modules 25 are located outside the load paths L1, L2 that form in the event of a collision, depending on the size and overlap of the collision partners, and are therefore particularly well protected from damage. In the event of a side impact, the cross members 39, 41 form load paths L3 and L4 through the receiving space 23, with the load being transferred to these cross members via the outer side members 29.

It should be noted that the side members 35, 37 are arranged in the receiving space 23 for the battery modules 25 in such a way that they connect to the side members 7 at least in the front region and, in the exemplary embodiment shown here in FIG. 1, also to the side members 13 in the rear region of the body-in-white 3. With this arrangement and design of the side members 7, 35, 37, 13, a continuation of a side member structure of the body-in-white 3 from the front end is achieved beyond the drive battery 19, i.e., past its battery modules 25 and beyond. In this way, forces acting on the body-in-white 3 in the event of a collision are not transferred to the drive battery 19, but are instead channelled through it without mechanically stressing the battery modules 25.

After all, it is clear that the side members 35 and 37 arranged within the receiving space 23 of the frame structure 27 are only subjected to a tensile-compressive load in the event of a collision (frontal and rear impact) due to the front-end side members 7 and rear-end side members n13 arranged in alignment with the frame structure 27 at least in their connection regions thereto, i.e., the load paths L1 and L2 are straight or rectilinear in the longitudinal direction of the vehicle (x-direction). Bending stress on the inner side members and cross members is therefore avoided—preferably completely—or at least reduced to a harmless level.

FIG. 1 also shows that, in this exemplary embodiment, the inner side members 35, 37 and the respective pairs of side members 7, 13, which are connected virtually in extension to opposite end regions, are also directly connected to each other by means of a connecting element 45 bridging the respective cross member 31 or 33 above. Of course, in this embodiment, the front side members 7 are also connected additionally to the front cross member 31, as are the inner side members 35, 37. The same also applies to the rear-side end of the inner side members 35, 37, which are connected to the rear cross member 33, wherein the rear side members 13 are also connected likewise to the cross member 33.

As already described, the battery modules 25 are arranged between the side members 29, 35, 37, 29 and cross members 31, 39, 41, 33 in the receiving space 23 and are thus integrated into the body-in-white 3.

It should also be noted that in the completed state of the passenger car, the free ends of the side members 7 of the front end structure 5 and also those of the side members 13 of the rear end structure 11, to each of which a bumper or a bending cross member of a bumper device or the like is attached, are at a higher level in the vehicle vertical direction (z-direction in the vehicle coordinate system), i.e., are at a greater distance from the road surface than the frame structure 27 in the centre region of the body-in-white 3. In order to nevertheless be able to realize an at least partial overlap of these side members 7, 13 with one of the side members 35, 37 in the receiving space 23 in their connection region on or close to the respective cross member 31 or 33 of the frame structure 27, in order to achieve a lateral-offset-free and thus bending-moment-free introduction of crash forces via the side members 7 to 13 into the side members 35, 37, the rear side members 13 are designed to slope downwards in an arc in the direction of the frame structure 27, as is readily apparent from FIG. 1, while in the case of the front side members 7, their connection region to the cross member 31 of the frame structure 27 has a correspondingly large extent in the motor vehicle height direction in order to compensate for the height offset, or else the respective side member 7 is connected to the respective damper leg bracket 10 and this has a corresponding height extent in its connection region to the cross member 31 of the frame structure 27, so that it can also be connected to the cross member 31. It is important that the side members 7 are designed and arranged within the body-in-white 3 in such a way that, in the event of a frontal impact of the passenger car, a straight load path L1 or L2 can form directly via the respective side member 7, i.e., without offset in the transverse direction of the vehicle and preferably in the vertical direction of the vehicle, into the respective inner side member 35 or 37. The same applies to the side members 13 arranged at the rear-end side of the vehicle, which then transfer the crash forces in the event of a rear-end collision into the aligned side members 35, 37 in the receiving space 23 without offset, i.e., in a straight line. In both cases, i.e., in the event of a frontal and rear impact, straight load paths L1, L2 are formed running in the longitudinal direction of the motor vehicle, which run past the battery modules 25 in accordance with the invention.

The side members 35, 37 and cross members 39, 41 in the receiving space 23 for battery modules 25 are designed, for example, as profiles, for example with a square, in particular square, cross-section or as an I-profile or as a differently designed profile. The side members 35, 37 each have a width of 50 mm, for example. The cross members 39, 41 each have a width of 40 mm to 60 mm, for example, wherein different widths can be provided. For example, one or more cross members 39, 41 have a width of 40 mm and one or more further cross members 39, 41 have a width of 60 mm. The battery modules 25 are each spaced apart from the side members 35, 37 and cross members 39, 41 in the receiving space 23, for example at a distance of 4 mm. This prevents any influence on the battery modules 25 in the event of collision-induced force transmission via the side members 35, 37 and/or cross members 39, 41 in the receiving space 23.

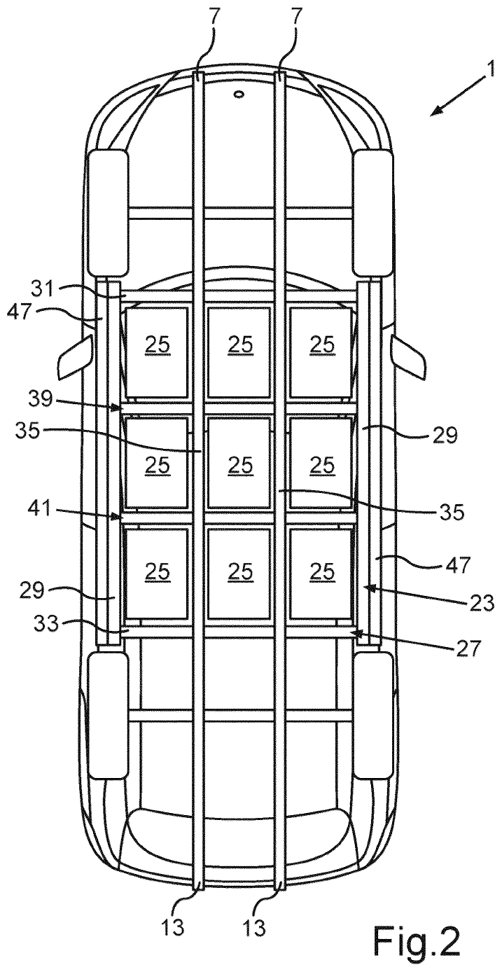

FIG. 2 shows a plan view of a further exemplary embodiment of the passenger car 1 according to the invention with a body-in-white 3 as described with reference to FIG. 1. Only the differences are described in greater detail below. The inner side members 35, 37 are arranged here at the same distance from each other as well as at the same distance from the outer side members 29, which form at least part of the respective side sill. The same applies to the inner cross members 39, 41, which are at the same distance from each other as well as at the same distance from the neighboring cross members 31 and 33 of the frame structure 27. This results in identically sized partial receiving spaces within the receiving space 23, into which identically sized battery modules 25 are inserted. A further difference compared to FIG. 1 is that the outer side members 29 project forwards and backwards beyond the front cross member 31 or the rear cross member 33 in the receiving space 23, for example by 5 mm, in particular in order to realize a connection to the front end or rear end of the vehicle, i.e., to the front or rear region of the body-in-white.

FIG. 2 also shows parts of a side wall 47 of the body structure which extend along the side members 29 and are usually attached and fastened to them. In one exemplary embodiment of the passenger car 1, a part of the side wall or a profiled element arranged on the inside of the side wall opposite the respective side member 29 forms part of the respective side sill.

A common feature of all exemplary embodiments is that there is no battery housing separate from the body-in-white 3. This means that no separate battery housing is provided; instead, the receiving space 23 for the battery modules 25 is formed by the body-in-white, which results in a high degree of integration. The side members 35, 37 and cross members 39, 41 in the receiving space 23 for the battery modules 25 are therefore each a component of the body-in-white. Here too, they are load-path-optimized for front and rear collisions and for side collisions. The battery modules 25 are inserted directly into this receiving space 23 formed in the body-in-white 3.

In both embodiments, it is achieved that the drive battery 19 or its carrier of the body-in-white 3 forming the battery housing 21 is load-bearing, wherein mechanical stress on the battery modules 25 and individual cells is avoided.

To summarize, in both embodiments the ladder frame structure is formed from side members 35, 37 and cross members 39, 41 for accommodating the battery modules 25 in the receiving space 23 and the side members 7 and 13 in the front end and in the rear end of the vehicle. The side members 35, 37 and cross members 39, 41 are provided here as a load path or as part of a load path L1 to L4 so that the drive battery 19 can be integrated into the body-in-white as a co-supporting structure.

The side members 35, 37 and cross members 39, 41 in the receiving space 23 are continuous or quasi-continuous in order to achieve optimized force guidance and optimized load paths without lateral misalignment. As described in FIG. 1, when forming a truss structure in which all side members and transverse members are arranged virtually in one plane, it is of course not possible to form all members continuously, but either at least one of the side members, in which case the adjacent cross members must be correspondingly multi-part, or at least one cross member, in which case the adjacent side members must be multi-part. Alternatively, it is conceivable that the side members and/or the cross members could each be formed in one piece, but each with a recess at which the carriers are inserted into each other. Such connections are familiar from carpentry-style timber beam connections, particularly in timber frame construction. It is important that the inner side members 35, 37 connect together the cross members 31, 33 of the frame structure 27, and the cross members 39, 41 connect the outer side members 29 of the frame structure 29. In particular, 90°—deflections of the load path are avoided, which generally leads to heavy junctions in the body-in-white. In particular, the continuation of the side member structure from the front end of the vehicle is provided in the drive battery 19, via the side members 35, 37 in the receiving space 23. The battery modules 25 are arranged between the side members 35, 37 and cross members 39, 41 in the receiving space 23 and are thus integrated into the body-in-white, but are not mechanically loaded. The receiving space 23 is sealed and closed at the bottom by the battery cover.

The solution described also enables functional integration of cooling and/or media routing in the battery cover, which is designed in particular in a honeycomb sandwich structure for this purpose. In one possible embodiment, this functional integration is therefore provided.

Alternatively or additionally, the solution described also enables, for example, the integration of sensors for measuring mechanical stresses, such as strain gauges, and/or temperature sensors and/or gas sensors, in particular for detecting gases escaping from the individual cells of the drive battery 19, for example in the event of a thermal runaway (of one or more battery cells), in the side members 35, 37 and/or cross members 39, 41 in the receiving space 23. This enables so-called health-monitoring, i.e., in particular condition monitoring, of the drive battery 19. For example, it can be determined whether the individual cells have been impermissibly deformed in the event of a collision with the passenger car 1. The sensors can be supplied with energy for example via energy harvesting, for example by absorbing energy from vibrations and converting it into electrical energy. In one possible embodiment, it is therefore provided that one or more sensors for measuring mechanical stresses, for example strain gauges, and/or one or more temperature sensors and/or one or more gas sensors are each integrated in at least one of the side members 35, 37 or several or all of the side members 35, 37 and/or in at least one of the cross members 39, 41 or several or all of the cross members 39, 41 in the receiving space 23 for the battery modules 25.

1. -6. (canceled)

7. A body-in-white (3) of a passenger car (1), comprising:
a frame structure (27) which is peripherally closed and which delimits a receiving space (23) for receiving a drive battery (19) having battery modules (25);
wherein the frame structure (27) is formed by first cross members (31, 33) which are spaced apart from one another in a longitudinal direction of the passenger car (1) and by first side members (29) which are spaced apart from one another in a transverse direction of the passenger car (1);
second side members (7, 13) adjoining the frame structure (27) in the longitudinal direction of the passenger car (1); and
third side members (35, 37) and second cross members (39, 41) disposed in the receiving space (23);
wherein the third side members (35, 37) connect the first cross members (31, 33) to one another and wherein the second cross members (39, 41) connect the first side members (29) to one another;
wherein the second side members (7, 13) adjoining the frame structure (27), as viewed in the longitudinal direction, each have, in a connection region to a respective first cross member (31, 33) of the frame structure (27), at least a partial overlap with the corresponding third side member (35, 37) disposed within the receiving space (23) such that, in an event of a collision-induced application of force in at least one of the second side members (7, 13), a load path (L1, L2) free of offset in the transverse direction is formed between the second side member (7, 13) and the third side member (35, 37) disposed directly behind it in the receiving space (23);
wherein the third side members (35, 37) and respective second side members (7) of a front-end structure (5) and/or second side members (13) of a rear-end structure (11), which are virtually connected in extension, are each directly connected to one another by a respective connecting element (45) bridging the respective first cross member (31, 33) above.

8. The body-in-white according to claim 7, wherein the third side members (35, 37) in the receiving space (23) are disposed adjacent to second side members (7) at least in a front region of the body-in-white and/or adjacent to second side members (13) in a rear region of the body-in-white.

9. The body-in-white according to claim 7, wherein the third side members (35, 37) are disposed in the receiving space (23) between the first cross members (31, 33) of the frame structure (27).

10. The body-in-white according to claim 7, wherein the second cross members (39, 41) are disposed in the receiving space (23) between the first side members (29) of the frame structure (27).

11. The body-in-white according to claim 7, wherein at least one third side member (35, 37) and/or one of the second cross members (39, 41) in the receiving space (23) consists of a plurality of partial elements (43a to 43b), wherein a total length of the plurality of partial elements (43a to 43b) is smaller than a distance between front and rear cross members (31, 33) or outer side members (29) of the frame structure (27).
